(19) United States
(12) Patent Application Publication
(10) Pub. No.: US 2003/0080997 A1
(43) Pub. Date: May 1, 2003

(54) Anonymous network-access method and client

(76) Inventors: Marcel Fuehren, Weert (NL); Jeng-Chun Chen, Taipei (TW)

Correspondence Address: U.S. Philips Corporation, 580 White Plains Road, Tarrytown, NY, 10591, US

(21) Appl. No.: 10/274,397

(22) Filed: Oct. 18, 2002

(30) Foreign Application Priority Data
Oct. 23, 2001 (EP) 01204020.0

(51) Int. Cl. G09G 5/00

(52) U.S. Cl. 345/744; 345/745

(57) ABSTRACT

A method in a proxy server (121) to provide anonymous access for a client device (101) to a network (110). The proxy server (121) receives request for a resource on the network (110) from the client (101), which resource is available on another server (122). The proxy server (121) removes all information identifying the client (101) from the request, and transmits the resulting anonymous request to the other server (122). The response from the other server (122) is passed on to the client (101). Also, an advertisement (210) is sent to the client (101) as a means of generating revenue. To target the advertisement (210), the client (101) maintains a user profile for the user and sends a subset of the user profile as a current interest profile to the proxy server (121). The proxy server (121) then selects the advertisement (210) based on the current interest profile.

The invention relates to a method of providing anonymous access for a client to a network, comprising receiving a request for a resource on the network from the client, creating an anonymous request by removing all information identifying the client from the request, transmitting the anonymous request to a server, transmitting a response from the server to the client and transmitting to the client at least one advertisement.

The invention further relates to a client device arranged for access to a network, comprising browsing means for transmitting a request for a resource on the network to a server, receiving the requested resource and receiving at least one advertisement, and presenting means for presenting the received resource together with the at least one advertisement.

The World Wide Web (WWW) is probably the largest network on the planet. All kinds of resources, ranging from text and images to audio, video and complete multimedia presentations, can be accessed on the many servers that are connected to the WWW. A problem with Web browsing is that, unlike information browsing in a library or kiosk, Web browsing is not anonymous. A Web server operator can monitor the resources being downloaded and use all kinds of information supplied voluntarily by Web browsers to learn about visitors of the Web site.

Using cookies, for example, it becomes possible to uniquely identify particular visitors of a Web site, even when successive visits by one particular visitor are several days apart. U.S. Pat. No. 5,948,061 discloses a method for targeting the delivery of advertisements to particular visitors, which in part relies on using cookies to identify the visitors.

Additionally, if the Web server operator is willing to use various tricks, even more information can be obtained from visitors. For example, some Web browsers can be tricked into automatically, and invisibly to their users, sending mail to an address chosen by the Web server operator. Using this trick, the operator can obtain the e-mail addresses of his visitors.

These and other privacy concerns have created a market for anonymous Web browsing services. A user no longer directly accesses the Web sites he wishes to visit, but instead submits the requests for resources to an anonymizing proxy server. The anonymizing proxy server strips all information that identifies the user, his computer or his browser from the request and forwards the anonymized request to the appropriate server. The response is then received by the anonymizing proxy server and sent back to the user's browser. This way, the server can learn nothing about the user, since all requests appear to originate with the proxy server.

The anonymizing proxy server can also remove potentially privacyendangering constructs from the responses it passes on to the user's browser. For instance, scripting code that causes the browser to automatically and invisibly send mail can be stripped from the response.

The anonymizing proxy server can be accessed manually, for example by entering URLs of desired resources in a form on a Web page provided by the proxy server. The anonymizing server can also be installed as a real proxy server in the browser's configuration. This way the operation of the anonymizing proxy server is entirely transparent to the user.

Of course the operator of the proxy server can now learn everything about the user's browsing habits. Most proxy server operators therefore publicly announce their monitoring policies and their privacy policy. Usually these policies include statements to the effect that no information on the individual users will be released to third parties such as advertisers and that no permanent records of browsing behaviors of individual users are kept.

While such a policy is necessary to convince users to use the proxy server, it makes the business model of the proxy server operator more difficult. Usually an advertisement-driven business model is used, in which the proxy server operator transmits one or more advertisements to the client, preferably together with the requested resource. The operator then receives money from the advertisers who supplied the advertisements.

However, since no records of browsing behaviors of individual users are kept, and no information on individual users can be released to third parties, it is very difficult if not impossible to target the advertisements to users of the anonymous browsing service. This makes the service less attractive to advertisers, since they do not know anything about their target audience. Hence, the payment to the proxy server operator will be lower than in the case where he could offer targeted advertisements to his users.

It is an object of the invention to provide a method according to the preamble, which allows targeting of advertisements yet preserves the anonymity of individual users of an anonymous browsing service.

This object is achieved according to the invention in a method which is characterized by receiving a current interest profile from the client, and selecting the at least one advertisement based on the current interest profile. The information in the current interest profile is a subset of information contained in a complete user profile for the user. The subset is targeted towards current interests of the user as determined on the client. Selecting an advertisement based on the current interest profile therefore gives a high degree of confidence that the advertisements will be targeted towards interests of the user.

Further, it is now more likely that the user will regard the advertisement as being unobtrusive and/or appropriate for his current browsing behavior. An advertisement that is targeted towards an interest of the user, but not to something he is presently involved with, is more likely to be regarded as useless or annoying, since its topic distracts from his present online activities. For example, an advertisement for his favorite game while he is shopping around to buy a new computer online would not be regarded as useful, even though it is targeted towards an interest of the user.

This method does not require transmitting any personal information on a user at all to the advertisers whose advertisements have been transmitted, nor is there any profiling information on an individual user that needs to be recorded permanently.

Having selected and transmitted the advertisements, the current interest profile is preferably discarded. This last step should also be explicitly mentioned in the privacy policy, so that users know that no permanent records of their browsing habits exist. Thus his anonymity and privacy is guaranteed.

It is known by itself to browse the Web in a more or less anonymous way by using a pseudonym or alias. The operator of a Web site can then learn the user's behavior but not his real name or address. Several solutions are available to facilitate pseudonym-driven Web access. For instance, in the article “Consistent, yet anonymous, Web access with LPWA” by E. Gabber et al., published in Communications of the ACM, vol. 42, no. 2, pp. 42-47, February 1999, a software system is described that allows users to browse the Web in a personalized, private and secure fashion using aliases generated by a Lucent Personalized Web Assistant (LPWA).

However, the current interest profile is not the same as a pseudonym or alias. With an alias, it is still possible to track the user's Web activities over time as he visits a Web site, although the tracked activities cannot be traced back to a real person. With a current interest profile, a Web site operator can learn nothing from the user's behavior, since there is no identifying information supplied to the Web site at all, not even a (consistent) alias.

In an embodiment the method further comprises supplying to the client a profiling module for maintaining a profile on the client, deriving from the profile a current interest profile and making the current interest profile available. This way, the client can easily generate the current interest profile. A third party can optionally certify the profiling module. This shows to the user who is about to install it that the module is legitimate and will not do anything behind the user's back.

In a further embodiment the method further comprises supplying the profiling module to the client as a plug-in module for a Web browser installed on the client. This has the advantage that it is very easy to install plug-in modules on a client device such as a personal computer. This lowers the barrier for accepting the profiling module.

In a further embodiment the method further comprises receiving the current interest profile over a secure channel. This has the advantage that no third parties can intercept the current interest profile as it is being transmitted over the network. For instance, the user's ISP or the company where the user works is normally in a position to monitor all network traffic, which would allow it to also monitor the current interest profile. By transmitting the current interest profile over a secure channel e.g. by encrypting it this is presented.

In a further embodiment the method further comprises maintaining a database of advertisements, whereby each advertisement is associated with profiling information, matching the current interest profile against the profiling information associated with the advertisements, and selecting the at least one advertisement as the best match.

For instance, each advertisement could be provided with a number of keywords that correspond to one or more possible interests, such as particular sports, holiday resorts, hobbies and so on. The current interest profile also contains a number of keywords identifying interests of the user. The keywords in the current interest profile can be compared against keywords associated with advertisements to find suitable targeted advertisements. This does not require transmitting any information at all to the advertiser, nor is there any profiling information on individual user that needs to be maintained on the server.

It is a further object of the invention to provide a client device according to the preamble, which allows targeting of advertisements yet preserves the anonymity of individual users of an anonymous browsing service.

This object is achieved according to the invention in a client device which is characterized by user profile maintenance means for maintaining a user profile based on requests transmitted via the browsing means, profile extraction means for creating a current interest profile as a subset of the user profile, and profile submission means for submitting the current interest profile to the server. By maintaining a user profile in the client device, it is possible to register the user's interests and preferences with a high degree of accuracy. The advertisements targeted based on this user profile are then highly likely to be effective.

However, it is not permitted to submit the user profile to the server since this is a violation of the privacy expected by the user. The profile extraction means create a current interest profile as a subset of the user profile. This way the current interest profile contains data that can be used to target advertisements accurately, but is in itself not sufficient to reconstruct a complete user profile for the user. Thus, the user's privacy is secured.

In an embodiment the user profile maintenance means are arranged for maintaining the user profile further based on usage of the client device. Usage information, such as the times during which the client device is used, can be a valuable source of information for user profile, and so it is advantageous to incorporate this in the user profile.

In a further embodiment the profile extraction means are arranged for creating the current interest profile by extracting from the user profile user data that is relevant to the request to be transmitted to the server. By correlating the current interest profile with a currently requested resource, it is likely that the advertisements received in return a highly targeted towards the topic of the requested resource. This makes the advertisements very effective.

The invention further relates to a profiling module for installation on a client device arranged for access to a network, comprising user profile maintenance means for maintaining a user profile based on requests for resources on the network, profile extraction means for creating a current interest profile as a subset of the user profile, and profile submission means for submitting the current interest profile to a server.

In an embodiment the profile extraction means are arranged for creating the current interest profile by extracting from the user profile user data that is relevant to the request to be transmitted to the server.

These and other aspects of the invention will be apparent from and elucidated with reference to the embodiments shown in the drawing, in which:

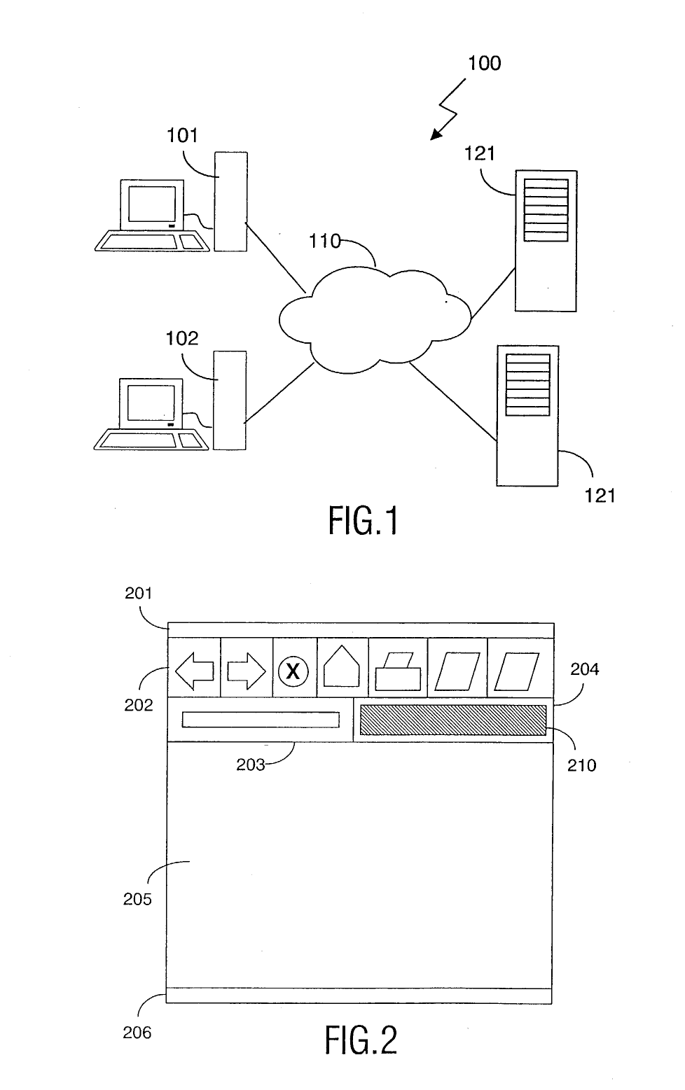

FIG. 1 schematically shows a network comprising servers and clients;

FIG. 2 schematically shows output generated by a Web browsing client;

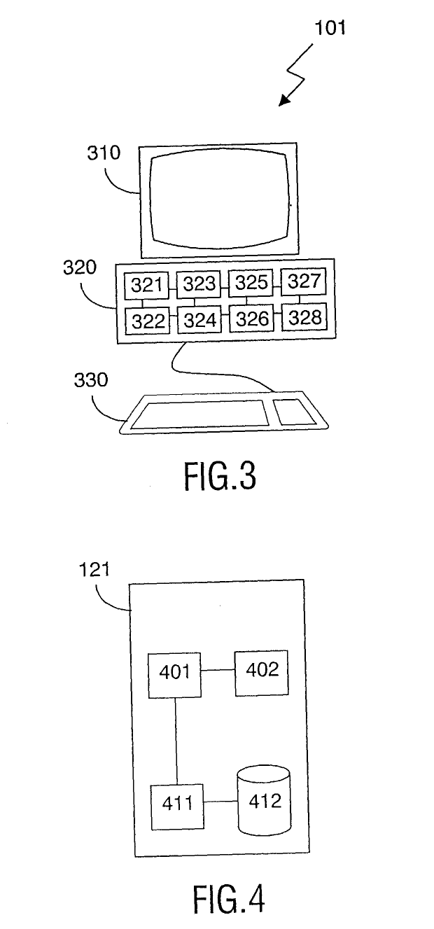

FIG. 3 schematically shows the Web browsing client in more detail; and

FIG. 4 schematically shows the proxy server in more detail.

Throughout the Figures, same reference numerals indicate similar or corresponding features. Some of the features indicated in the drawings are typically implemented in software, and as such represent software entities, such as software modules or objects.

FIG. 1 schematically shows an embodiment of a system 100 according to the invention. The system 100 comprises clients 101, 102 and servers 121, 122, all connected to a network 110 such as the Internet. The clients 101, 102 can be personal computers, laptop computers, or any of a variety of hand-held devices, running Web browsing software. The clients 101, 102 could also be consumer electronics (CE) devices such as a set-top box, a television or a gateway to an in-home network.

In case the network 110 comprises the Internet, then the clients 101, 102 could retrieve all resources available e.g. on the World Wide Web, but also resources available on FTP sites or resources available on file sharing networks such as Napster. In the last case, the network may be a peer-to-peer network, where the distinction between client and server is not always clear. A client is understood here to mean any device capable of retrieving resources from another device, which is then called the server, via the network 110 and presenting the retrieved resources to a user.

In the embodiment shown in FIG. 1, the user of client device 101 does not wish that a server operator from which client device 101 retrieved resources can collect personal information about his browsing habits. He therefore turns to server 121, which offers an anonymous Web browsing service. The user of client device 101 can now specify resources to be requested, which requests are then transmitted by the client device 101 to the server 121 rather than directly to the server on which the resource is made available.

Upon receiving a request, server 121 removes all information that could be used in identifying the user, the client device 101 or any computer program running on the client device 101. Examples of such information include the host name and/or IP-address of the client device 101, the e-mail address of the user, the configuration of the client device 101, the version number of the browser software running on the client device 101, or any cookies that were previously sent to the client device 101. All such information, as well as possibly other identifying information, is usually present in requests for resources.

The thusly anonymized request is then forwarded by the server 121, ostensibly originating from the server 121 itself, to the server that makes the requested resources available, e.g. server 122. The server 122 then transmits the requested resource back to the server 121, where it is passed on back to the client device 101. This way, the operator of server 122 cannot learn anything about the user or the client device 101.

To further protect the privacy of the user of the client device 101, the connection(s) between the client device 101 and the server 121 can be established over a secure channel, for example by using Secure Sockets Layer (SSL) or the Secure HyperText Transfer Protocol. This way, the Internet Service Provider (ISP) that provides the access to the network 110 for client device 101 cannot learn anything about the user's browsing habits either.

FIG. 2 schematically shows an example of possible output of Web browsing software running on the client device 101 when making use of the anonymous Web browsing service offered by server 121. It is to be understood that this example is shown for illustrative purposes only. Many different configurations and output possibilities exist.

In this case, the Web browsing software comprises a graphical browser such as Microsoft Internet Explorer, Netscape Navigator, Opera, Mozilla, Konqueror and so on. The output of the Web browsing software is divided into several parts, namely a title area 201, a toolbar area 202, a navigation area 203, an advertisement area 204, a presentation area 205 and a status bar area 206.

The title area 201 can present items such as the title of the resource currently being presented, as well as provide access to standard application controls such as a minimize, maximize or close button. The toolbar area 202 provides quick access to frequently used functions such as back, forward, stop and return to home page. The navigation area 203 can be used to enter specific resources to be retrieved e.g. by entering a Uniform Resource Locator. Any resources retrieved are presented in the presentation area 205, unless more appropriate helper applications or plug-ins exist. Status information can be provided in the status bar area 206.

The operator of server 121 uses an advertisement-driven business model to make money on its anonymous Web browsing service. At certain intervals, the server 121 transmits to the client device 101 one or more advertisements. These are then displayed in advertisement area 204, as is the case in FIG. 2: an advertisement 210 is presently being shown. Alternatively, the advertisement 210 could be presented in a separate window created by the browsing software, i.e. a pop-up or pop-under window, or in a dedicated application.

Preferably the at least one advertisement is sent to the client device 101 when a requested resource is received by the server 121 and passed on to the client device 101. Alternatively, the server 121 can transmit advertisements to the client device 101 at periodic intervals or use some other criterion to determine when new advertisements should be transmitted. It could also be the client device 101 which is arranged to periodically fetch new advertisements from the server 121 for display in the advertisement area 204.

It is desirable that the advertisement 210 is not a generic advertisement, but is targeted towards the user of client device 101 in some fashion. This way the revenue received by the operator of server 121 from the advertisement supplier will be larger. Traditionally, advertisements can be targeted by maintaining on the server a profile of individual users. Such a profile comprises information regarding the user's browsing habits, lifestyle, interests, favorite search keywords and other information that can be gathered by observing the user's browsing behavior.

When offering an anonymous Web browsing service, maintaining such a profile on the server 121 is out of the question. People make use of the service exactly because they do not want to reveal personal information to anyone. The anonymous Web browsing service operators therefore publicly announce their monitoring policies and their privacy policy. Usually these policies include statements to the effect that no information on the individual users will be released to third parties such as advertisers and that no permanent records of browsing behaviors of individual users are kept.

In accordance with the invention, in order to still be able to deliver targeted advertisements to users of the service, the operator of server 121 requires that users install a profiling module on the client device 101. This profiling module could be supplied to the client device 101 upon first using the service, e.g. in the form of an ActiveX™ component, a Java™ applet or a specific application that is to be downloaded and installed.

The server 121 can be configured to refuse usage of the service if the profiling module is not installed, or offer only limited access to service if the profiling module is not installed. For example, the transfer speed could be reduced, the number of resources that can be accessed in one session could be restricted, and so on. The operations performed by the profiling module will be explained below.

FIG. 3 schematically shows an embodiment of the client device 101 in more detail. In this embodiment the client device 101 comprises a television 310 coupled to a settop box 320. The set-top box 320 provides the access to the network 110 as well as other functionality necessary to retrieve and present resources available thereon. Also connected to the set-top box 320 is an input device 330, here a keyboard. Of course other input devices such as mice, joysticks, remote controls could also be used.

The set-top box 320 comprises various modules 321-328, whose workings will become apparent below. Some or all of the modules 321-328 can be realized in software provided on a storage medium inside or connected to the set-top box 320, which is then executed by a processor in the set-top box 320.

A networking module 321 provides the actual access to the network 110. It can be realized for instance as an Ethernet card coupled to the network 110 together with the appropriate control software. Alternatively, a modem connected to a telephone line or other mechanisms such as a cable modem could be used.

A browsing module 322 submits requests for resources available on the network 110 using the networking module 321. It also retrieves the responses to those requests. The retrieved resources are then passed on to a rendering module 323, which presents them on the television 310 unless more appropriate helper applications or plug-ins exist. The rendering module 323 could have created the output shown in FIG. 2. A combination of browsing module 322 and rendering module 323 is conventionally available in software as a Web browser.

Also available is a configuration module 324, which allows the user of the client device 101 to configure operations performed on the device 101 to work according to his preferences. Various conventional options can be configured using this module 324. One of the available options is a proxy server to be used in browsing the Web. When this option is selected and a proxy server has been specified, any requests for resources are passed on to the proxy server rather than directly to the server from which the resource is available.

In this embodiment, the user has configured that the server 121 is to be used as proxy server. This way he transparently accesses the anonymous Web browsing service provided by the server 121. Alternatively, he could simply go to the homepage of the anonymous Web browsing service and manually request resources he wants to retrieve anonymously in a form interface.

As stated above, use of the anonymous Web browsing service according to the invention requires that a profiling module is installed in the client device 101. The profiling module comprises three components 325, 326 and 327.

A user profile maintenance component 325 monitors the requests submitted by the browsing module 322. This could be done for instance by monitoring the communication between the browsing module 322 and the networking module 321, or by calling a function available in the Application Programmer's Interface (API) of the browsing module 322.

Based on the monitored requests, the user profile maintenance component 325 maintains a user profile for the user. This can be done for instance by determining a topic of the requested resource e.g. by extracting keywords, and registering this topic as being of interest to the user in the user profile. Metadata such as the topic of the resource could also be obtained from a server connected to network 110. For example a document with metadata formatted in the Resource Description Format (RDF) is often available for the requested resource. This document could be used in maintaining the user profile based on the requests.

It may be desirable to maintain different user profiles for different users, although this requires that each user identifies himself when he starts using the client device 101. While this is usually practical in the case of software running on a general-purpose computer, when the client device 101 comprises a television, identifying individual users is not very straightforward.

The user profile maintenance component 325 may further obtain details of the client device 101 and/or details of usage of the client device 101 and incorporate those in the user profile. For example, the user profile maintenance component 325 may track the times at which the user uses the client device 101 for Web browsing, and the times at which he uses the client device 101 for watching television programs. Details of the television programs watched by the user could also be incorporated into the user profile.

Details of television programs could be obtained by reading from an Electronic Program Guide the titles and subjects of the programs. If in the last hour the user has watched an action movie, an advertisement targeted towards action games or new action movies available on DVD or in the theatre is likely to be successful. Similarly, if the user has watched a sports program on golf, an interest in “sports/golf” could be incorporated into the profile and an advertisement for a golf magazine or for golf clubs might find interest. Similarly, if recent past behavior included listening to a CD from Madonna, then an advertisement for the newest CD from Madonna would be appreciated. Note that, next to interests in particular subjects, also the times at which these interests were derived are recorded in the user profile.

Any personal preferences such as those entered using the configuration module 324 are also incorporated into the user profile. Such personal preferences could for instance indicate whether the user is interested in multimedia applications: if no plug-ins for multimedia applications are installed, it is likely that the user is not interested in those.

The user profile is stored in the client device 101, in this embodiment in storage medium 328 inside the set-top box 320. Preferably the user profile is stored in an encrypted fashion so that theft of the set-top box 320 does not expose private data. Also, encrypting the user profile prevents other applications running on the set-top box 320 from accessing the user profile and abusing the information contained therein.

The configuration module 324 could be arranged to allow customization of the level of abstraction and type of information that is or is not recorded in the user profile. A menu can be provided in which the user can enter data for inclusion in the user profile, for example by answering a questionnaire.

When the user is actively browsing resources available on the network 110 using the anonymous Web browsing service, advertisements targeted in accordance with the user profile are to be presented in advertisement area 204. The advertisements to be transmitted to the client device 101 are selected in the server 121, but it is not permitted to submit the user profile to the server 121 since this is a violation of the privacy expected by the user.

To solve this problem, a profile extraction component 326 creates a current interest profile as a subset of the user profile. Preferably the profile extraction component 326 creates the current interest profile by extracting from the user profile user data that is relevant to the request to be transmitted to the server 121. This way the current interest profile contains data that can be used to target advertisements, but is in itself not sufficient to reconstruct a complete user profile for the user. Thus, the user's privacy is secured.

The profile section component 326 can use a variety of techniques to create a current interest profile. For example, it could extract only that information that is relevant to the topic of the last few resources presented to the user. Individual topics could be abstracted and only the abstract topics are included in the current interest profile. For instance, if the user visited several Web sites related to several soccer teams, the current interest profile could include the topic “soccer” rather than the names of the soccer teams.

Preference could also be given to those interests recorded in the user profile that were recorded in the recent past, while ignoring or marginalizing interests from longer ago. The recent past could for instance be the last few hours, or from the moment on that the set-top box 320 was turned on for the current usage session. In particular, preference can advantageously be given to those interests recorded in the last hour.

Of course interests recorded longer ago can also be useful in constructing a current interest profile. For example, if the user profile consistently shows that the user hates gardening shows, yet he just watched one, it would be wrong to include a liking towards gardening shows in the current interest profile. Such a situation may occur for instance when the set-top box 320 was in fact operated by another person than the user for whom a user profile is being recorded, or when the user left the television 310 on because he was doing something else. So, the interests extracted from the user profile and incorporated into the current interest profile should be substantially consistent with the user profile as a whole.

The profile extraction component 326 then passes the current interest profile to a profile submission component 327, which submits the current interest profile to the server 121. Preferably the current interest profile is submitted to server 121 over a secure channel such as an SSL link. This way third parties such as the user's ISP cannot intercept multiple current interest profiles and learn nothing about the user's browsing habits.

FIG. 4 schematically shows the server 121 in more detail. The server 121 comprises a networking module 401, which receives requests for resources from the client device 101. Anonymizing module 402 removes from these requests all information that could be used in identifying the user, the client device 101 or any computer program running on the client device 101.

The anonymizing module 402 then forwards the thusly anonymized request, ostensibly originating from the server 121 itself, to the server 122 that makes the requested resources available. The server 122 then transmits the requested resource back to the server 121, where it is received by the networking module 401 and passed on back to the client device 101.

At certain moments the networking module 401 receives from the client device 101 a current interest profile. The current interest profile is forwarded to a profiling module 411, which selects the at least one advertisement to be transmitted to the client device 101 based on the current interest profile.

The server 121 is connected to a database 412 containing advertisements. These advertisements and receives from the advertisers with which the proxy server operator has a business relationship. Each advertisement is associated with profiling information. The profiling module 411 can select the at least one advertisement to be transmitted to the client device 101 by matching the current interest profile against the profiling information associated with the advertisements, and selecting the at least one advertisement as the best such match. Having selected and transmitted the advertisements, the current interest profile is discarded. This last step should also be explicitly mentioned in the privacy policy, so that users know that no permanent records of their browsing habits exist.

For instance each advertisement could be provided with a number of keywords that correspond to one or more possible interests, such as particular sports, holiday resorts, hobbies and so on. The current interest profile also contains a number of keywords identifying interests of the user. The keywords in the current interest profile can be compared against keywords associated with advertisements to find suitable targeted advertisements. This does not require transmitting any information at all to the advertiser, nor is there any profiling information on individual user that needs to be maintained on the server 121.

The server 121 does maintain a list of advertisements that were sent to client devices. However, this list does not identify individual client devices, but only provides aggregated information such as “Advertisement X from advertiser Y was transmitted 25 times in the last week”. Based on this aggregated information, the server operator can send a bill to the advertisers.

Some users do not want to see any advertisements during their Web browsing activities, and are willing to pay to avoid them. So, optionally the server operator of server 121 could provide a subscription service for those users in which no advertisements are transmitted to their client devices. However it is to be expected that this group of users will be a minority.

It should be noted that the above-mentioned embodiments illustrate rather than limit the invention, and that those skilled in the art will be able to design many alternative embodiments without departing from the scope of the appended claims.

For instance, rather than storing advertisements in the database 412 at the server 121, alternatively the database 412 could comprise information related to of advertisers. The server 121 can establish real-time connections with each of these advertisers, preferably when a current interest profile is received at the server 121. Using this real-time connection, the server 121 transmits the received current interest profile to a selected one of the advertisers. The advertiser then creates or selects in real-time a targeted advertisement based on that profile and sends it to the server 121, which forwards it to the client device 101. The advertiser would in this case be able to log real-time current interest profiles, which should be extremely attractive as they could in real-time adjust commercial offers. The server operator can charge more for providing this facility to the advertiser. At the same time the advertiser would have no knowledge to whom a particular current interest profile belongs to, or any historic data, so privacy is maintained. A win-win for all.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of providing anonymous access for a client to a network, comprising receiving a request for a resource on the network from the client, creating an anonymous request by removing all information identifying the client from the request, transmitting the anonymous request to a server, transmitting a response from the server to the client and transmitting to the client at least one advertisement, characterized by receiving a current interest profile from the client, and selecting the at least one advertisement based on the current interest profile.

2. The method of claim 1, further comprising supplying to the client a profiling module for maintaining a profile on the client, deriving from the profile a current interest profile and making the current interest profile available.

3. The method of claim 2, further comprising supplying the profiling module to the client as a plug-in module for a Web browser installed on the client.

4. The method of claim 1, further comprising receiving the current interest profile over a secure channel.

5. The method of claim 1, further comprising maintaining a database of advertisements, whereby each advertisement is associated with profiling information, matching the current interest profile against the profiling information associated with the advertisements, and selecting the at least one advertisement as the best match.

6. A client device arranged for access to a network, comprising browsing means for transmitting a request for a resource on the network to a server, receiving the requested resource and receiving at least one advertisement, and presenting means for presenting the received resource together with the at least one advertisement, characterized by user profile maintenance means for maintaining a user profile based on requests transmitted via the browsing means, profile extraction means for creating a current interest profile as a subset of the user profile, and profile submission means for submitting the current interest profile to the server.

7. The client device of claim 6, the user profile maintenance means being arranged for maintaining the user profile further based on usage of the client device.

8. The client device of claim 6, the profile extraction means being arranged for creating the current interest profile by extracting from the user profile user data that is relevant to the request to be transmitted to the server.

9. A profiling module for installation on a client device arranged for access to a network, comprising user profile maintenance means for maintaining a user profile based on requests for resources on the network, profile extraction means for creating a current interest profile as a subset of the user profile, and profile submission means for submitting the current interest profile to a server.

10. The profiling module of claim 9, the profile extraction means being arranged for creating the current interest profile by extracting from the user profile user data that is relevant to the request to be transmitted to the server.
